(19) United States
(12) Patent Application Publication
(10) Pub. No.: US 2015/0088523 A1
(43) Pub. Date: Mar. 26, 2015

(54) Systems and Methods for Designing Voice Applications

(71) Applicant: Michael Schuster, Saratoga, CA (US)

(72) Inventor: Michael Schuster, Saratoga, CA (US)

(73) Assignee: GOOGLE INC., Mountain View, CA (US)

(21) Appl. No.: 13/608,193

(22) Filed: Sep. 10, 2012

(51) Int. Cl. G10L 21/00

(52) U.S. Cl. 704/275

(57) ABSTRACT

Examples disclose a method and system for designing voice applications. The method may be executable to receive a verbal input, parse the verbal input to recognize a keyword, and identify a plurality of applications associated with the recognized keyword. Moreover, the method may be further executable to determine a relevance and/or payment associated with the verbal input and/or keyword, to identify one or more applications that are already installed on a computing device, and to initiate or offer to initiate the identified installed application based on the determined relevance and/or payment. When an installed application is not identified, the method may be executable to identify one or more applications from a plurality of relevant candidate applications and present one or more of the identified relevant candidate applications to a user for possible installation. The payment may be based on whether the identified application is already installed on the computing device.

### BACKGROUND

The ability for a user to verbally converse with a machine was once thought to be merely science fiction. However, as time progressed, so too has peoples' understanding of how speech recognition occurs and how speech recognition systems may be used to process and recognize verbal inputs. One mechanism used to facilitate recognition of verbal inputs is a grammar. A grammar may define a language and includes a syntax, semantics, rules, inflections, morphology, phonology, etc. A grammar may also include or work in conjunction with a vocabulary, which may include one or more words. Speech recognition systems may use the grammar and the vocabulary to recognize or otherwise predict the meaning of a verbal input and, in some cases, to formulate a response to the verbal input.

Grammars can be time consuming and complex to create. Moreover, once created, it may be difficult to transport the grammar to a different environment or to alter the grammar to work in conjunction with a different vocabulary. The ability to use the same or similar grammar in multiple environments can save a developer and/or company time and money.

### SUMMARY

The present application discloses, inter alia, methods and systems for designing voice applications.

Any of the methods described herein may be provided in a form of instructions stored on a non-transitory, computer readable medium, that when executed by a computing device, cause the computing device to perform functions of the method. Further examples may also include articles of manufacture including tangible computer-readable media that have computer-readable instructions encoded thereon, and the instructions may comprise instructions to perform functions of the methods described herein.

The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage medium.

In addition, circuitry may be provided that is wired to perform logical functions in any processes or methods described herein.

In still further examples, many types of devices may be used or configured to perform logical functions in any of the processes or methods described herein.

In yet further examples, many types of devices may be used or configured as means for performing functions of any of the methods described herein (or any portions of the methods described herein).

For example, a method may be executable to receive a verbal input from a computing device, parse the verbal input to recognize a keyword, and identify a plurality of applications associated with the recognized keyword. For each of the plurality of applications, the method may be executable to identify a relevance associated with the recognized keyword and determine a priority of the plurality of applications based on the relevance associated with the recognized keyword, wherein a first priority may be associated with an application responsive to a first relevance being identified and a second priority may be associated with the application responsive to a second relevance being identified, wherein the first priority may be greater than the second priority responsive to the first relevance being greater than the second relevance. The application associated with the first priority may be sent to the computing device.

In another example, a system may include at least one processor, a non-transitory computer-readable medium, and program instructions stored on the non-transitory computer-readable medium and executable by the at least one processor to cause the computing system to perform a number of functions. The functions may include receiving a verbal input from a computing device, parsing the verbal input to recognize a keyword, identifying a plurality of applications associated with the recognized keyword, and for each of the plurality of applications, identifying a payment associated with the recognized keyword. The functions may also include determining a priority of the plurality of applications based on the payment associated with the recognized keyword, wherein a first priority is associated with a given application responsive to a first payment being identified and a second priority is associated with the application responsive to a second payment being identified, wherein the first priority is greater than the second priority responsive to the first payment being greater than the second payment. The system may provide the application associated with the first priority to the computing device.

In another example, a system may include an interface to receive a plurality of keywords associated with an application. The system may also include a payment module to receive a payment associated with at least one of the plurality of keywords. Moreover, the system may further include a matching module to match a verbal input to at least one of the plurality of keywords, wherein the matching module may also identify from among a plurality of applications the application associated with at least one of the matched plurality of keywords and to prioritize the application among the plurality of applications based at least in part on the payment. The system may also include a transfer module to provide the application associated with the matched at least one of the plurality of keywords to a computing device.

Another example may include a non-transitory computer-readable medium having stored thereon instructions executable by a computing device having at least one processor to cause the computing device to perform a number of functions. The functions may include parsing a verbal input, identifying a keyword associated with the parsed verbal input, and making a determination that an application installed on the computing device is associated with the identified keyword. Based on the determination, the computing device may receive at least one candidate application associated with the identified keyword, receive an input selecting the at least one candidate application, initiate the at least one candidate application based on receipt of the input, and based on initiation of the at least one candidate application, perform an action associated with the parsed verbal input.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 illustrates a block diagram showing some components of an example server;

FIG. 2 illustrates a block diagram of an example method for identifying an application associated with an input;

FIG. 3 illustrates an example embodiment for selecting an already installed application using a verbal input;

FIG. 4 illustrates an additional example embodiment for selecting an already installed application using a verbal input;

FIG. 5 illustrates another example embodiment for selecting a not yet installed application using a verbal input;

FIG. 6 illustrates an example embodiment for communicating with a selected application using a verbal input; and

FIG. 7 illustrates another example embodiment for communicating with a selected application using a verbal input.

### DETAILED DESCRIPTION

In the following detailed description, reference is made to the accompanying figures. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The following detailed description generally describes a system and a method to identify, design, and/or develop voice applications. The system and method make it possible for application developers to use existing vocabularies and/or grammars to design voice applications without interaction from a speech team. In particular, the following description describes a system and a method that allows voice application developers to use an existing grammar and to define a vocabulary to work in conjunction with the existing grammar. By utilizing an existing grammar and defining a vocabulary, developers may be able to define voice actions or voice inputs that may prompt the voice application to initiate or otherwise launch, to perform the action, to respond to the input, etc. In this way, voice actions may be defined without the interaction of a separate speech team to test and/or deploy the voice action in any country or supported language. Moreover, the voice actions may be available from the top speech input layer, may provide sufficiently accurate recognition within the application, and may have limited to no effect on the accuracy of the speech recognition. Furthermore, by allowing developers to define all or part of the vocabulary associated with the application, the described systems and methods may provide a mechanism that may make it easier for users to understand the voice actions and to facilitate growth of the vocabulary and voice application as a whole. In some embodiments, the ability for an application to use an existing grammar and be associated with a vocabulary may be provided for free, for a fee, or on a subscription basis.

More specifically, application developers may use the systems and/or methods described herein to define one or more keywords that may be associated with an application or a website. The definition process may be performed by the developer, or any other party, using an interface provided via a server, such as an application programming interface (API) or any other communication interface. Thus, for example, the server may allow the developer to add or identify an application or website. The server and/or developer may associate the application or website with one or more keywords and/or phrases, which the developer may enter or select using the API. In embodiments, the keywords and/or phrases may be used to trigger the application or website and may be provided for free, for a fee, based on a subscription, etc. Moreover, in some embodiments the server may allow the developer to update the application, the website, keywords, phrases, etc. for free, for an additional fee, as part of the subscription, etc.

The keywords and/or phrases may be part of a vocabulary that the server may offer to the developer and/or may be defined by the developer. The vocabulary may broadly include a number of words or phrases that may be used in conjunction with a provided grammar. In embodiments, the vocabulary may refer to a verbal vocabulary and/or a written vocabulary.

In some embodiments, the server may provide the developer with a possible vocabulary, keywords and/or phrases to include in the vocabulary, keywords and/or phrases to exclude from the vocabulary, etc. However, in other embodiments, the server may prompt the developer to submit a list of keywords and/or phrases that may be used to define a possible vocabulary. In yet further embodiments, a hybrid vocabulary may be provided wherein the developer provides a subset of the keywords and/or phrases in a vocabulary and the server provides the remaining keywords and/or phrases in the vocabulary based on keyword and/or phrase analytics, which may include historical data, the type of application or website associated with the vocabulary, the developer, etc.

The size of the vocabulary may vary based on the application or website, an amount paid for the vocabulary, the language(s) represented by the vocabulary, etc. In some examples, the size of the vocabulary may be well over one million words and may include words in a plurality of different languages. In another example, however, the vocabulary may be smaller so as to allow for a relatively faster speech recognition and/or higher speech recognition quality. The smaller vocabulary may include those keywords and/or phrases that may be specific to the application, specific to the website, and/or likely to be used in conjunction with the application or website. Thus, for example, a first vocabulary may be associated with a first type of application while a second vocabulary may be associated with a first type of application or website. The first vocabulary may be different from the second vocabulary or may include one or more of the same keywords and/or phrases.

In some embodiments, the developer may define a full grammar or a partial grammar, which may be associated with one or more vocabularies. However, since the creation of grammars may be complex and time-consuming, a full or partial grammar may be provided by the server to the developers complete with meaning graphs and probabilities. The provided grammar may be available for free with the keywords, phrases, and/or vocabulary. Optionally, the provided grammar may be available for a fee or on a subscription basis, for example. The server may validate, compile, and/or store the provided grammar and/or the developer defined grammar for future use with the vocabulary.

In addition to the foregoing, the server may also be used to define how the application or website may be triggered verbally. An example of the triggering process may include a server, cloud, user's mobile telephone, or any other computing device receiving a verbal input associated with a spoken or otherwise verbalized keyword and/or phrase. Upon receipt, the receiving device (e.g., the user's mobile telephone) may perform speech recognition on the verbal input using any number of language models, acoustic models, decoding procedures, etc. that may be implemented by or otherwise running on the receiving device, for example. In some examples, one or more functions of the voice recognition process may be performed by a different computing device, such as a server, cloud, etc. Moreover, in yet further examples, a plurality of computing devices may be employed to perform part or all of the speech recognition process.

In some embodiments, the speech recognition process may be implemented at least in part using a server-side or client-side speech decoding procedure. The speech decoding procedure may include adding the keywords and/or phrases, which may have been defined by the developer, included in the vocabulary, and/or included in a universal vocabulary, to a speech hypothesis. Thus, for example, the decoding procedure may compare all or part of the verbal input to the speech hypothesis and disregard keywords and/or phrases falling outside of the speech hypothesis.

Upon recognizing one or more keywords and/or phrases in the verbal input, the server, the receiving device, or the like, may determine if the recognized keywords and/or phrases substantially match one or more keywords and/or phrases associated with an application or website (such as the application or website that was added by the developer, or an application or website that may reside on the user's mobile telephone or computing device.) If a match occurs, a list of substantially matching applications and/or websites may be generated by the server, receiving device, etc. and displayed to the user via a computing device, for example. The user may launch the application or website by selecting (e.g., via a verbal input or a physical gesture, such as a click, tap, double tap, etc.) one of the substantially matching applications or websites from the list. In some embodiments, the launching may be performed automatically by the computing device based on predefined user settings and/or based on a learning algorithm's analysis of the user's prior selections, behavior, interactions, the relevance of the verbal input, etc.

By utilizing the vocabulary and/or grammar, the application or website may be identified without requiring the developer to produce or interfere with the language model, the acoustic model, the decoding procedure(s), etc. that may be implemented or otherwise running on the server, cloud, user's mobile telephone, user's computing device, etc. This may improve the speech recognition rate, the consistency of speech recognition, and/or the quality of the voice search application, for example.

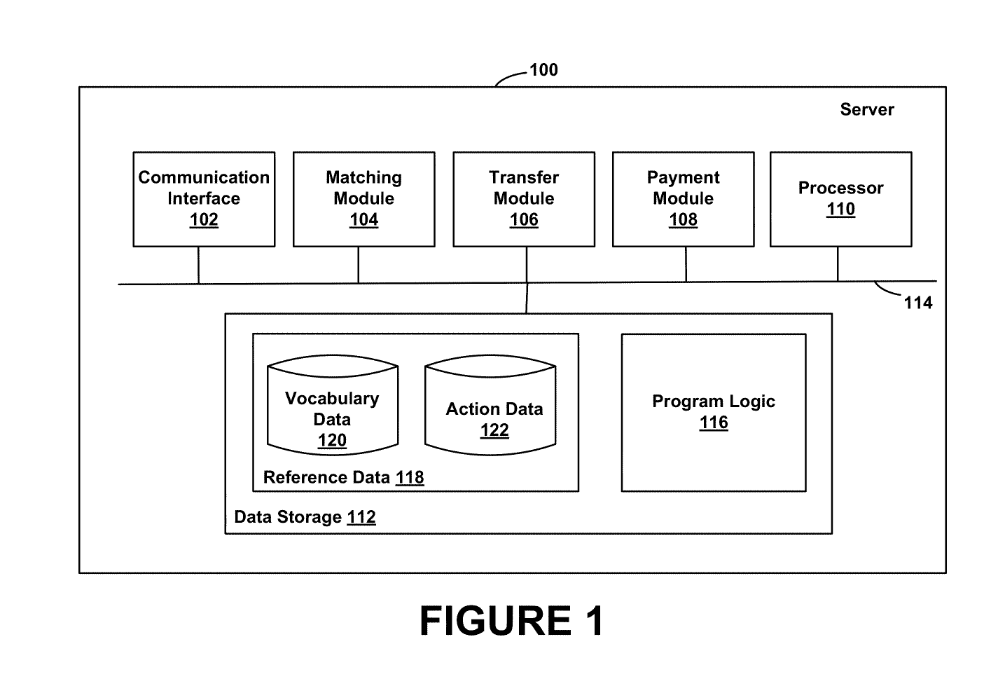

FIG. 1 illustrates a block diagram showing some of the components of an example server 100. In some examples, some of these components or their functions may be distributed across multiple servers. However, the components are shown and described as part of a representative server for sake of example. The server 100 may be a computing device, cloud, or similar structure that may be configured to perform the functions described herein. The computing device may broadly include workstations, desktop computers, notebook computers, tablet computers, network enabled printers, scanners and multi-function devices, personal digital assistants, email/messaging devices, cellular phones, etc.

As shown in FIG. 1, the example server 100 includes a communication interface 102, a matching module 104, a transfer module 106, a payment module 108, a processor 110, and a data storage 112, all of which may be communicatively linked together by a system bus, network, or other connection mechanism 114. In embodiments, the connection mechanism 114 may be a wired connection such as a serial bus or a parallel bus. The connection mechanism 114 may optionally be a proprietary connection, or a wireless connection using, for example, Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities.

The communication interface 102 may be an API and may allow the server 100 to communicate with another device. Thus, a function of the communication interface 102 may be to receive input from a device, such as a computing device. In addition to receiving inputs, the communication interface 102 may also output data to the computing device. In embodiments, communication interface activity data may be maintained and managed (e.g., by the server 100) to provide a record of communications involving the computing device.

For example, an application developer or other party may communicate with the communication interface 102 via a computing device. The application developer may utilize the computing device to upload an application to the server, action as an application store, for example. The application developer may also select one or more words that, when recognized in conjunction with the application, result in an action associated with the application being performed. Thus, the application developer could identify the keyword “Bank” as being associated with opening or otherwise starting the user's uploaded bank application.

The matching module 104 may be configured to parse the received input (such as a verbal or textual input) and match all or part of the received input to at least one of (1) the plurality of keywords and/or phrases, (2) a grammar, (3) an application or website, (4) etc. As an example, the matching module 104 may receive input from the communications interface 102 in the form of an application. The matching module 104 may identify characteristics of the application based on the application and/or inputs associated with the application. The matching module 104 may use this information to identify one or more keywords or a vocabulary that the matching module 104 may associate with the application. The matching module 104 may communicate information to the communication interface 102, which may in turn communicate the information to the user via the computing device, for example. In this way, the user may be presented with one or more keywords and/or a vocabulary in which to associate with the application. In some embodiments, the application developer may optionally or additionally identify keywords and/or phrases to associate with the application and the associated keyword may be sent to the matching module 104 so as to train the matching module 104 to match the application to the keywords and/or phrases, for example.

In another example, the matching module 104 may receive an input from the communication interface 102, wherein the input is a request for a specific application and/or an application associated with a keyword. The matching module may receive this input and identify an application that may match the input, for example. Thus, a user may use a computing device to request a “Bank” application, the matching module 104 may identify a “Bank” application (e.g., from within an application store) and may send and/or offer to send the bank application to the computing device for free, for a fee, and/or on a subscription basis.

In embodiments, the transfer module 106 may be configured to send application, website, and/or data associated with the application and/or website to a computing device. Moreover, in embodiments, the transfer module 106 may also send the vocabulary, grammar, keyword, phrase, etc. associated with the application and/or website to the computing device. In embodiments, the transfer module 106 may send the application, website, data, etc., to the computing device automatically or upon the happening of an event. The event may include a selection of the application by a user or other party via the computing device, a preference defined by a user or party, or any number of other events.

In further embodiments, the payment module may be configured to receive a payment. The payment may be associated with one of the plurality of keywords and/or phrases, a vocabulary, a grammar, an application, a website, etc. The type of payment received by the payment module may vary in embodiments and may include a fee based payment structure, a free service, a subscription service, etc. Thus, for example, the payment module may receive a payment form a user uploading an application to an application store, wherein the payment may be associated with the vocabulary, keywords, phrases, etc. that the user would like associated with the application.

Processor 110 may comprise one or more general purpose processors (e.g., microprocessors) and/or one or more special purpose processors (e.g., digital signal processors, or application specific integrated circuits). Data storage 112 may include one or more volatile and/or non-volatile storage components, such as magnetic, optical, flash, or organic storage, and may be integrated in whole or in part with the processor 110. As shown, the data storage 112 of the example server 100 may include program logic 116 and reference data 118.

Program logic 116 may take the form of machine language instructions or other logic executable or interpretable by the processor 110 to carry out various server functions described herein. By way of example, the program logic 116 may include an operating system and one or more application programs installed on the operating system. Distributed among the operating system and/or application programs may then be program logic 116 for providing calling functionality, interaction functionality, and functions specific to example methods described herein.

In embodiments, the program logic 116 may be used to facilitate the association of the keywords, vocabulary, and/or grammar, with the application such that a received verbal input can be recognized and associated with an application. The associated application may then be sent to the user via the transfer module 106, for example.

In an example, the referenced data, vocabulary data, and/or action data may be communicated to the user via the communication interface 102 so as to allow the user to associate the reference data with the uploaded application and/or website. In a further example, the program logic 116 may be used to associate the reference data with the application and/or website with little to no interaction from the user.

Reference data 118, may include vocabulary data 120 and/or action data 122. Vocabulary data 120 may include one or more words and/or phrases that define the vocabulary. The action data 122 may include one or more actions that may be associated with one or more words and/or phrases defined in the vocabulary. In embodiments, the action data 122 may further include instructions executable by the computing device, for example.

As an example, a computing device may communicate with the server 100 via the communication interface 102. The communication may include the computing device, for example, sending, uploading, or otherwise making available an application or website information to the server 100. The communication may also include information identifying the application and/or website information to the server. This identifying information may include one or more keywords and/or phrases that may be associated with the application and/or website. Optionally, in embodiments, the server may use the identifying information to determine (e.g., via reference data 118 and/or vocabulary data 120) one or more keywords and/or phrases that may be applicable to the application or website and provide the one or more keywords and/or phrases to the computing device

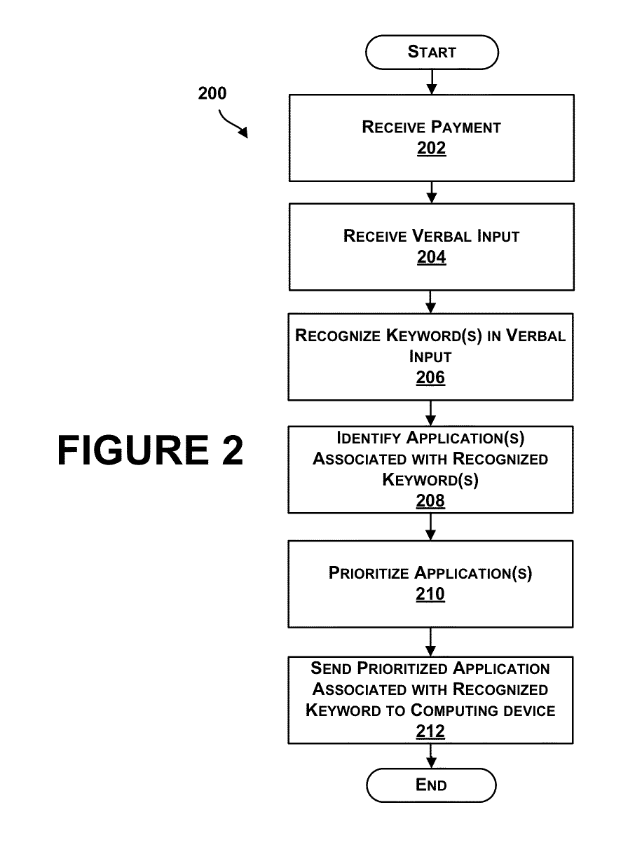

FIG. 2 is a block diagram of an example method for identifying an application associated with an input, in accordance with at least some embodiments described herein. Method 200 shown in FIG. 2, presents an embodiment of a method that, for example, could be used with the systems 100, and may be performed by a device, such as a computing device, or components of the device. The various blocks of method 200 may be combined into fewer blocks, divided into additional blocks, and/or removed based upon the desired implementation. In addition, each block may represent a module, a segment, or a portion of program code, which includes one or more instructions executable by a processor for implementing specific logical functions or steps in the process. The program code may be stored on any type of computer readable medium, for example, such as a non-transitory storage device including a disk or hard drive.

In addition, for the method 200 and other processes and methods disclosed herein, the flowchart shows functionality and operation of one possible implementation of the present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include a non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage system. The computer readable medium may be considered a computer readable storage medium, for example, or a tangible storage device.

At block 202, the method 200 includes receive payment. The payment may be received by a server. In embodiments, the payment may be received in conjunction with one or more keywords and/or phrases, and the keywords and/or phrases may be provided by the server and/or by a third party interacting with the server via a computing device, for example. The amount of the payment may vary based on the keyword and/or phrase being purchased, the popularity of the keyword and/or phrase, the number of times the keyword and/or phrase is received as a verbal input, an action associated with the keyword, etc. Thus, for example, a first payment may be associated with a first keyword that may be associated with the application and/or website and a second payment may be associated with a second keyword associated with the application and/or website. The first payment may represent a price for associating the keyword to the application. In embodiments, the first payment may also or optionally be representative of an amount to cause an application installed on the computing device to start, for example. The second payment may represent a price for associating the keyword to the application and, optionally, causing the application to install and start, for example. The second payment may be higher than the first payment. In some embodiments, the first payment and/or the second payment may be static or dynamic in that the price to install and/or launch an application based on a keyword may vary based on time, date, popularity of the keyword and/or application, etc.

Upon receipt of the payment, the server may associate one or more of the keywords and/or phrases with an application or website identified by the third party. The association may be stored in a database, for example, and may be used to determine what keywords and/or phrases may be used and/or recognized when the application or website is in use.

At block 204, the method 200 includes receive verbal input. The verbal input may be any form of verbal communication including words, phrases, utterances, or the like. In embodiments, the verbal communication may also include indications of intonation, tone, pitch, inflection, etc. The verbal communication may originate from a user, electrical device, and/or electro-mechanical device and may be received by a computing device, such as a mobile telephone, a personal digital assistant, etc. The computing device may send the verbal input directly or indirectly to the server.

At block 206, the method 200 includes recognize keyword(s) in verbal input. In embodiments, the recognition may include parsing a phrase that may have been received by the server to identify one or more keywords in the phrase. The recognition of the keywords may be performed in any number of ways using a variety of voice recognition algorithms. In some embodiments, a probability or likelihood of success may be associated with the recognized keyword and a determination may be performed as to the identity of the keyword. In embodiments, recognized keywords may be compared to a database of keywords to identify a meaning associated with the keyword.

A grammar may be used to aid in recognizing keywords and/or phrases. The grammar may be provided with the keywords, thereby allowing the grammar to be used with the application and/or website associated with the application.

In some embodiments, the server may use speech recognition algorithms to determine or otherwise identify an inflection, pitch, intonation, tone, etc. that may be associated with the received keyword and/or phrase. For example, the server may determine an inflection and use the determination to identify a tense, person, gender, mood, etc. In another example, the server may identify a pitch and use the pitch to order sounds using a frequency related scale. In yet another example, intonation may be used to determine a variation of pitch. Moreover, the server may determine a tone and use the tone to determine a lexical or grammatical meaning associated with the keyword and/or phrase, for example.

In other examples, keywords may be recognized by providing the voice input to a speech recognition server, and receiving a response from the recognition system.

At step 208, the method includes identify application(s) associated with recognized keyword(s). The process of identifying an application associated with a recognized keyword may be performed by the server. In embodiments, the server may perform this process by comparing the recognized keyword to a database of keywords (such as vocabulary data 120) that may be associated with one or more applications and/or websites, action data, etc.

At step 210, the method includes prioritize applications. The prioritization of applications and/or websites may be based on a number of factors including a relevance of a keyword matching an application, a payment associated with a keyword matching an application, etc. In embodiments, the prioritization may be performed by matching module at the server using data received, for example, from the payment module 108. The process of prioritizing applications and/or websites may include the server determining all or a subset of the applications and/or websites that may be associated with the recognized keyword. The server may also determine a relevance of the keyword associated with one or more applications and use the relevance in full or in part to prioritize the applications. Moreover, the server may determine how much, if any, payment was received for the keyword and/or phrase to be associated with the application and/or website. This payment amount may be determined based on an average amount per keyword and/or phrase, a subscription level, a weighted payment, a time, a date, a geographic location, etc. In embodiments, the payment amount may be used to determine the relevance of the keyword associated with the applications. Optionally, the payment amount may be used as an independent factor that may be used alone or in conjunction with one or more factors, such as the relevance of the keyword associated with the application, in determining the priority associated with the application.

As an example, a party may select a plurality of keywords to be associated with an application. The party may pay a rate per keyword, a first rate for first number of keywords, a second rate for a second number of keywords, etc. The first rate and/or the second rate may be pro rata or a flat rate. The party may optionally pay a first rate for a first keyword, a second rate for a second keyword, etc. The rate per keyword may be based on any number of factors including the popularity of the keyword, the likelihood that the keyword will be identified or otherwise received by the server, etc. The rate per keyword may additionally or optionally be associated with data from any number of sensors associated with the computing device that may be used to facilitate the party's communication with the server. Thus, for example, a first rate may be associated with a keyword when the party is in a first location and a second rate may be associated with the keyword when the party is in a second location. Similarly, the rate per keyword may be based on the time at which the keyword is received, applications and/or websites associated with the keyword, applications and/or websites running or otherwise available on the computing device facilitating the communication between the party and the server, etc. The payment associating the keyword and/or phrase to the application and/or website may be used to prioritize the application and/or website.

In some embodiments, the server may prioritize the applications and/or websites based solely on the payment amount associated with the keyword and/or phrase associated with the applications and/or websites. Alternatively, the server may prioritize the keywords and/or phrases based on a context learned from the keyword, sensor data, etc. In some embodiments, the server may identify a likelihood that the application and/or website may be relevant given the inflection, pitch, intonation, tone, etc. associated with the keyword, sensor data, etc. and use the likelihood that the application and/or website may be relevant to aid in prioritizing one or more of the applications and/or websites. Thus, the server may prioritize applications and/or websites associated with the recognized keyword and/or phrase, for example.

At block 212, the method 200 includes send prioritized application associated with recognized keyword to computing device. More specifically, upon prioritizing one or more applications and/or websites, the server may send the application and/or website with the highest priority, with the highest likelihood of relevancy, etc. to the computing device. Optionally, the server may send an identifier associated with the application and/or website that may allow the application and/or website to be run server-side. Prior to sending the application and/or website to the computing device, the server may prompt or otherwise request permission to send the application and/or website to the computing device. Permissions may be defined at the computing device and may include any number of options that may allow or restrict the server from sending the application and/or website to the computing device.

As an example, a party may upload an application to an application store (e.g., the server) and pay for one or more keywords to be associated with the application. The server may receive and store this information. The server may also receive verbal inputs from one or more computing devices that the server may parse to determine if the verbal inputs include a keyword that is associated with one or more of the uploaded application. If so, the server may prioritize the applications that are associated with the recognized keyword and suggest the application having the highest priority to the third party interacting with the computing device. The third party may choose to download the application, may request alternative applications, may request a trial use of the application, etc. If the third party chooses to download or otherwise try the application, the server may send the application to the computing device. The server may also, in embodiments, send the keywords and/or phrases associated with the application, all or part of the grammar used in conjunction with the keywords and/or phrases, etc. to the computing device. Optionally, one or more grammars available on the computing device may be used in conjunction with the keywords and/or phrases. The computing device may use the grammar, keywords, phrases, etc. to allow the third party to interact with the application without requiring the application developer to create a special grammar, design voice actions or semantic actions, determine what languages to be implemented, or any number of time consuming and error prone aspects that are often required in creating an application. In some embodiments, this process may be facilitated by one or more machine learning algorithms, thereby allowing an organic growth of voice actions.

In some embodiments, the server may receive data in the form of feedback from the computing device. The feedback may indicate whether one or more of the applications that were sent and/or presented to the computing device were purchased, downloaded, initiated, terminated, deleted, etc. In embodiments, this data may be associated with the verbal input and may also or optionally be used by the server to identify and/or modify a priority associated with one or more of the applications. Thus, as an example, if the server receives feedback that a prioritized application was sent to the computing device, but not initiated, then the server may adjust the priority associated with the prioritized application to reflect the end user's preferences, historical usage, etc. Therefore, for example, a priority associated with an application that was sent to a computing device may be decreased if the application was not launched or increased when the application was launched.

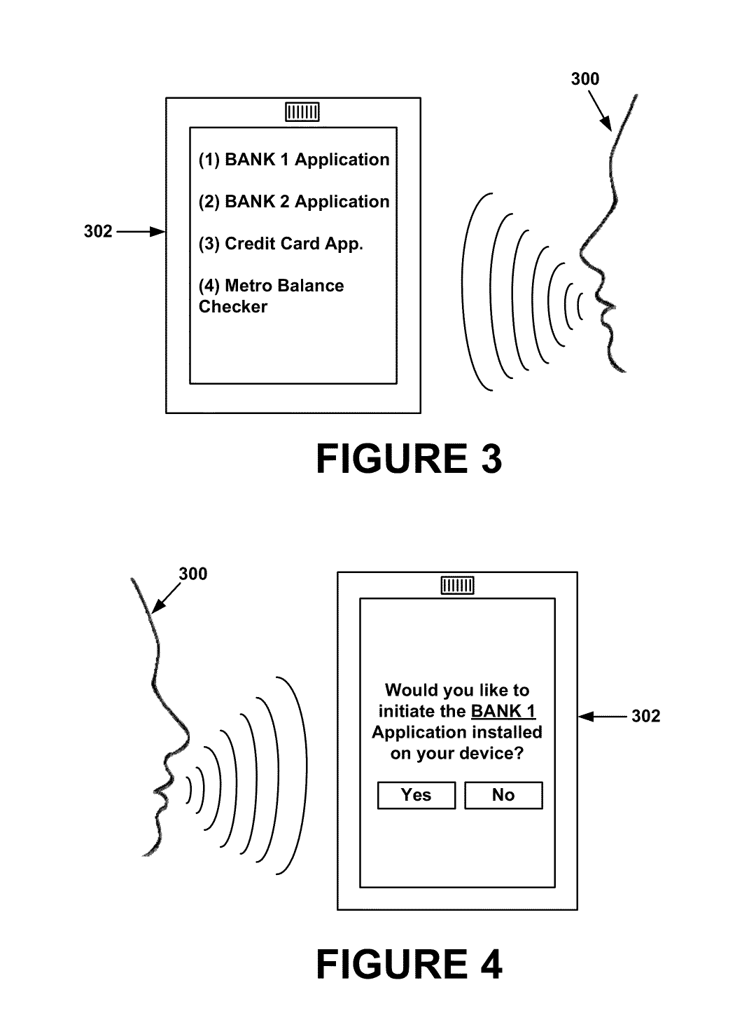

FIG. 3 illustrates an example embodiment for selecting an already installed application using a verbal input, in accordance with at least some of the embodiments described herein. In particular, FIG. 3 includes a party 300 interacting with a computing device 302 to select an application. The computing device 302 may be operable to communicate with a server, cloud, or other construct that may provide software, data access, storage and/or computing resources, etc. The server may receive an application and one or more words associated with the application from an application developer. The one or more words may be associated with the application based on a relevance, a payment, or other factors described elsewhere herein. Thus, for example, an application developer may develop a banking application and communicate with a server to select one or more words to associate with the banking application. Example words may include “Bank,” “Bank 1,” “Bank 2,” “account,” “balance,” “checking,” “savings,” and/or any number of additional or alternative words. The application developer may pay for each word or a combination of words. The amount paid for a word and/or group of words may affect whether an application installed at the computing device 302 is initiated, whether one or more applications are suggested to the party 300, etc.

The party 300 may interact with the computing device 302 to select an application. This interaction may include the party 300 verbalizing the word “Bank”. The computing device 302 may receive the verbal input “Bank” and use any number of speech recognition algorithms in conjunction with a top level voice search grammar, for example, to recognize the word “Bank” and/or identify an application and/or website on the computing device 302 that may be associated with the word “Bank”. The computing device 302 may display or otherwise convey audibly or visually one or more applications or websites that may match the verbal input. Thus, for example, the computing device 302 may perform an Internet search for results that may match the word “Bank”.

In some examples, multiple applications and/or websites may be identified as matching the word “Bank”. In such cases, the results may be presented to the party 300 via the computing device 302. The order that the results are presented may be based on an amount of money that was paid to associate the application and/or website to the word “Bank”. Alternatively, the order that the results are presented may be based on the relevancy of the application and/or website, the frequency at which the application and/or website is selected when the party 300 verbalizes the word “Bank”, etc. Thus, if the party 300 banks at BANK 1, an application or website for BANK 1 may be presented before BANK 2, for example. The party 300 may respond by selecting one of the presented applications and/or websites, by requesting that the computing device 302 obtain one or more additional applications and/or websites from the server, etc. Once the party 300 has selected an application and/or website using the existing grammar and vocabulary, the party 300 may continue to verbally interact with the application and/or website using the same or substantially similar grammar and vocabulary, for example.

In some embodiments, the computing device may send feedback to the server indicating that an application and/or website has been selected, identified, or otherwise utilized responsive to the verbal input. The server may use this feedback to determine a new priority or adjust an existing priority for the application and/or related applications. In further embodiments, the server may use this and/or other data to determine the frequency at which the application was initiated, for example. The server may modify the priority of one or more of the applications based on the determined frequency. Thus, an application that is comparatively frequently initiated at one or more computing devices may be deemed more popular and may be associated with a higher priority than an application having a comparatively low frequency, for example.

FIG. 4 illustrates an additional example embodiment for selecting an already installed application using a verbal input, in accordance with at least some of the embodiments described herein. In particular, FIG. 4 includes the party 300 and the computing device 302 of FIG. 3. However, in FIG. 4, the application developer paid a first payment amount to associate the word “Bank” with the “Bank 1” application. In exchange for the payment, the “Bank 1” application may be launched or otherwise initiated in response to the verbal input “Bank.”

More specifically, the computing device 302 may receive the verbal input “Bank.” The computing device 302, or a server, may recognize the verbal input as the word “Bank” and identify one or more applications on the computing device 302 associated with the word “Bank.” Thus, for example, the computing device 302 may recognize the “Bank 1” application as associated with the word “Bank” and may further determine (via a database lookup, metadata, or other mechanism) that the application developer paid a first payment amount to associate the word “Bank” with the “Bank 1” application. Based on the first payment amount, the computing device 302 may initiate the application on the computing device 302. In those examples where multiple applications on the computing device 302 are associated with the word “Bank,” and more than one of the applications is also associated with the first payment, then the computing device 302 and/or the server may determine a priority of the applications that are associated with the first payment and the word “Bank.” This priority may be based on the same or similar factors as described in reference to FIG. 2, for example. Alternatively, embodiments may avoid prioritization by limiting the number of applications that may be associated with the word “Bank” and initiated responsive to the verbal input “Bank.”

In some embodiments, automatically launching or starting an application or website may be a preference that may be defined by the party 300 and may be related to the party's 300 history of selecting one or more applications and/or websites when the word “Bank” is verbalized, for example. Thus, the party 300 may choose to be asked prior to initiating an application, even if a first payment amount is associated with the application.

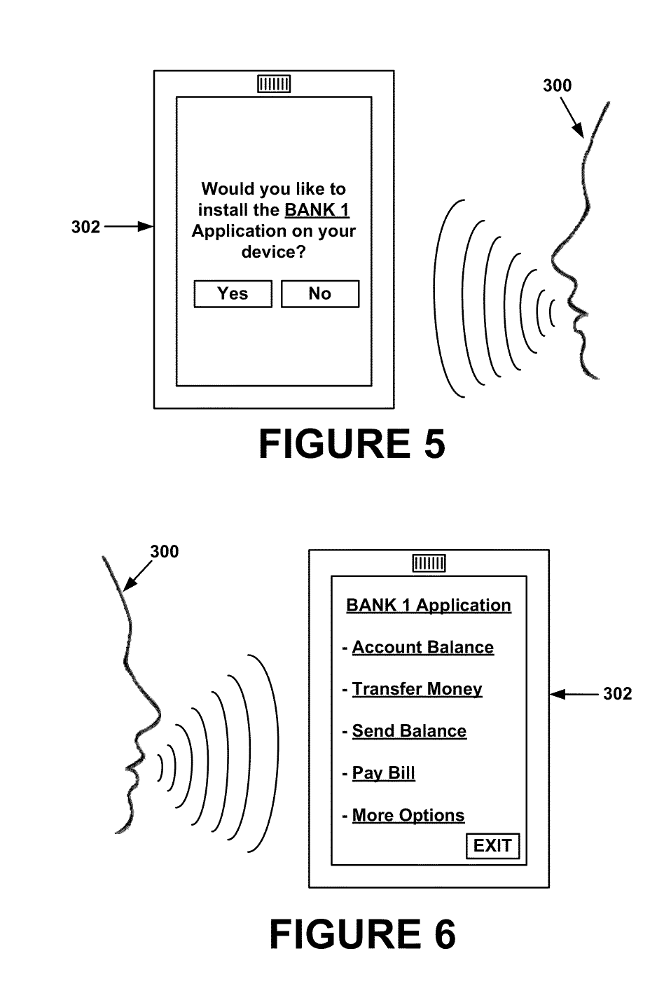

FIG. 5 illustrates another example embodiment for selecting a not yet installed application using a verbal input in accordance with at least some of the embodiments described herein. In particular, FIG. 5 includes the party 300 and the computing device 302 of FIG. 3. However, in FIG. 5, the application developer paid a second payment amount to associate the word “Bank” with the “Bank 1” application. The second payment amount may be more than, less than, or the same as the first payment amount. In exchange for the payment, the “Bank 1” application may be identified and provided to the party 300 as a possible application for installation. In some embodiments, if the party 300 decides to install the application, the computing device 302 may launch or otherwise initiate the newly installed application.

More specifically, the computing device 302 may receive the verbal input “Bank.” The computing device 302, or a server, may recognize the verbal input as the word “Bank” and attempt to identify one or more applications on the computing device 302 associated with the word “Bank.” The computing device 302 may also communicate with the server to identify one or more applications associated with the word “Bank” that are not installed on the computing device 302. In some embodiments, the computing device 302 may communicate with the server each time the computing device 302 attempts to identify a candidate application or, optionally, only in those circumstances where an identified application is not installed on the computing device 302.

Thus, for example, the computing device 302 may communicate with the server to identify an application that is associated with the word “Bank” and the second payment amount. When multiple applications are identified, the server may prioritize the identified applications based on the same or similar factors as described in reference to FIG. 2, for example. The server may provide one or more of the identified applications to the computing device 302 and allow the party 300 to select one or more of the applications for installation. Once installed, the computing device 302 may optionally initiate the application.

FIG. 6 illustrates an example embodiment for communicating with a selected application using a verbal input in accordance with at least some of the embodiments described herein. More specifically, FIG. 6 includes the party 300 interacting with the computing device 302 after launching the “BANK 1 Application.” The party 300 may interact with the application via the computing device 302 using verbal inputs such as “Transfer $50 from savings.” As the party 300 is interacting with the “BANK 1 Application”, the computing device 302 may forego performing an Internet search for a website that may be associated with the verbal input “Transfer $50 from savings.” Optionally, the computing device 302 may perform the Internet search while the “BANK 1 Application” is being executed and, in embodiments, continue to present applications and/or websites to the party 300 while the party 300 is interacting with the “BANK 1 Application” or after the party 300 terminates the “BANK 1 Application”, for example.

The computing device 302 may receive the “Transfer $50 from savings” verbal input and parse the input to identify a keyword and/or meaning associated with the input using the application, for example. In some embodiments, applications may utilize one or more forms of speech control, which may be used to aid in parsing verbal inputs, recognizing words within the verbal inputs, etc. Thus, for example, the application may parse the verbal input “Transfer $50 from savings” and identify the words “transfer” and/or “savings.” The application, with the aid of the computing device 302, may compare the words “transfer” and/or “savings” to one or more actions that may be available to the party 300. This process may result in the application identifying “transfer money” as a possible and/or likely action. The application, via the computing device 302, may prompt the party 300 to confirm or reject the hypotheses that the party 300 would like to “transfer money.” If confirmed, the application, via the computing device 302, may present information associated with transferring money. The application may also associate the phrase “Transfer $50 from savings” with “transfer money” so as to learn from the user's verbal input and selection.

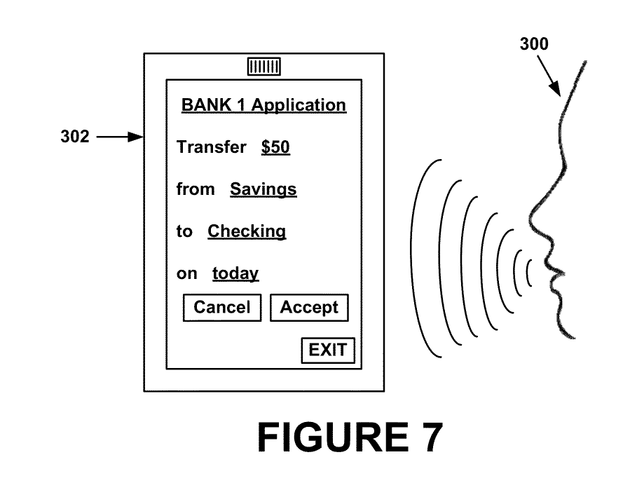

FIG. 7 illustrates another example embodiment for communicating with a selected application using a verbal input in accordance with at least some of the embodiments described herein. In particular, FIG. 7 includes the party 300 interacting with the “BANK 1 Application” after verbalizing “Transfer $50 from savings” and being presented with a display to facilitate the transfer of money. The application, via the computing device 302, may identify the word “$50” in the verbal input and determine that the party 300 may want to transfer $50. The application may use historical data, heuristics, programmed or learned preferences, etc. to determine that the party 300 will likely transfer money from a savings account to a specified checking account. The application may likewise determine the date that the transfer should occur or use a default date or time. The application, via the computing device 302, may present the information to the party 300 to obtain a confirmation that the party 300 wants to transfer $50 from savings to checking today. If the application does not receive a confirmation after a predetermined amount of time the application may time-out without taking an action. If the application receives a confirmation, the application may facilitate the transfer of $50 from savings to checking today. The application may refrain from taking additional action until the application receives a verbal, physical, or other input from the party 300 instructing the application to perform another action. If a predetermined amount of time has elapsed, the application may time-out, thereby resulting in the application being terminated, reverting to a previous screen, automatically performing an action based on the party's historical, learned, or programmed behavior, etc.

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

Since many modifications, variations, and changes in detail can be made to the described example, it is intended that all matters in the preceding description and shown in the accompanying figures be interpreted as illustrative and not in a limiting sense.

1-20. (canceled)

21. A method comprising:
parsing, at a computing device, a verbal input, wherein the computing device is in communication with a server, the computing device includes a constrained speech recognition search space, and the verbal input includes a plurality of words;
identifying at least one keyword at the computing device using the constrained speech recognition search space;
communicating with the server to identify at least one keyword at the server;
determining, by the computing device, a plurality of applications based on the at least one keyword identified at the computing device and the at least one keyword identified at the server;
assigning, by the computing device, respective priorities to respective applications of the plurality of applications based at least on: (i) whether a respective application is installed on the computing device or is yet to be installed, (ii) a payment made to associate the identified keywords with the respective application, and (iii) a relevance of the respective application to the identified keywords; and
providing a ranked list of the plurality of applications based on the respective priorities;
receiving feedback information indicative of a selection of an application of the plurality of applications;
modifying the respective priorities assigned to the plurality of applications based on the feedback information; and
associating, by the computing device, the modified respective priorities with the identified keywords.

22. The method of claim 21, further comprising:
storing, based on the feedback information, preference information indicative of a preference for an installed application or a yet to be installed application, wherein modifying the respective priorities assigned to the plurality of applications is further based on the preference information.

23. The method of claim 21, wherein the payment varies based on a geographic location of the computing device and a time of day at which the verbal input is received.

24. The method of claim 21, wherein the feedback information is further indicative of a request for an alternative set of applications, and wherein modifying the respective priorities assigned to the plurality of applications comprises:
decreasing the respective priorities assigned to the plurality of applications.

25. The method of claim 21, further comprising:
receiving a subsequent verbal input including the keyword; and
providing a modified ranked list of the plurality of applications based on the modified respective priorities.

26. The method of claim 21, wherein modifying the respective priorities assigned to the plurality of applications comprises:
increasing the respective priority assigned to the selected application and decreasing the respective priorities of remaining application of the plurality of applications.

27. The method of claim 21, further comprising:
determining a frequency at which the respective application is selected; and
further modifying the respective priority of the selected application based on the frequency.

28. The method of claim 21, further comprising:
for the selected application being installed on the computing device, initiating the application; and
for the selected application being yet to be installed on the computing device, requesting permission to download, install, and initiate the application.

29. (canceled)

30. The method of claim 21, wherein determining the plurality of applications comprises:
identifying a subset of applications that are installed on the computing device; and
communicating with a server to identify one or more applications that are yet to be installed on the computing device.

31. A non-transitory computer-readable medium having stored thereon instructions that, when executed by a computing device, cause the computing device to perform functions comprising:
parsing a verbal input, wherein the computing device is in communication with a server, the computing device includes a constrained speech recognition search space, and the verbal input includes a plurality of words;
identifying at least one keyword at the computing device using the constrained speech recognition search space;
communicating with the server to identify at least one keyword at the server;
determining a plurality of applications based on the at least one keyword identified at the computing device and the at least one keyword identified at the server;
assigning respective priorities to respective applications of the plurality of applications based at least on: (i) whether a respective application is installed on the computing device or is yet to be installed, (ii) a payment made to associate the identified keywords with the respective application, and (iii) a relevance of the respective application to the identified keywords; and
providing a ranked list of the plurality of applications based on the respective priorities;
receiving feedback information indicative of a selection of an application of the plurality of applications;
modifying the respective priorities assigned to the plurality of applications based on the feedback information; and
associating the modified respective priorities with the identified keywords.

32. The non-transitory computer-readable medium of claim 31, wherein the functions further comprise:
storing, based on the feedback information, preference information indicative of a preference for an installed application or a yet to be installed application, wherein modifying the respective priorities assigned to the plurality of applications is further based on the preference information.

33. The non-transitory computer-readable medium of claim 31, wherein the payment varies based on a geographic location of the computing device and a time of day at which the verbal input is received.

34. The non-transitory computer-readable medium of claim 31, wherein the feedback information is further indicative of a request for an alternative set of applications, and wherein the functions of modifying the respective priorities assigned to the plurality of applications comprises:
decreasing the respective priorities assigned to the plurality of applications.

35. The non-transitory computer-readable medium of claim 31, wherein the functions further comprise:
receiving a subsequent verbal input including the keyword; and
providing a modified ranked list of the plurality of applications based on the modified respective priorities.

36. A system comprising:
a computing device; and
a memory having stored thereon instructions that, when executed by the computing device, causes the system to perform functions comprising:
parsing a verbal input, wherein the computing device is in communication with a server, the computing device includes a constrained speech recognition search space, and the verbal input includes a plurality of words;
identifying at least one keyword at the computing device using the constrained speech recognition search space;
communicating with the server to identify at least one keyword at the server;
determining a plurality of applications based on the at least one keyword identified at the computing device and the at least one keyword identified at the server;
assigning respective priorities to respective applications of the plurality of applications based at least on: (i) whether a respective application is installed on the computing device or is yet to be installed, (ii) a payment made to associate the identified keywords with the respective application, and (iii) a relevance of the respective application to the identified keywords; and
providing a ranked list of the plurality of applications based on the respective priorities;
receiving feedback information indicative of a selection of an application of the plurality of applications;
modifying the respective priorities assigned to the plurality of applications based on the feedback information; and
associating the modified respective priorities with the identified keywords.

37. The system of claim 36, wherein the function of modifying the respective priorities assigned to the plurality of applications comprises:
increasing the respective priority assigned to the selected application and decreasing the respective priorities of remaining application of the plurality of applications.

38. The system of claim 36, wherein the functions further comprise:
determining a frequency at which the respective application is selected; and
further modifying the respective priority of the selected application based on the frequency.

39. (canceled)

40. The system of claim 36, wherein the function of determining the plurality of applications comprises:
identifying a subset of applications that are installed on the computing device; and
communicating with a server to identify one or more applications that are yet to be installed on the computing device.
